(19) United States
(12) Patent Application Publication
(10) Pub. No.: US 2015/0346472 A1
(43) Pub. Date: Dec. 3, 2015

(54) MICROSCOPE SYSTEM WITH DEPTH PREVIEW AND MICROSCOPY METHOD

(71) Applicant: Carl Zeiss Meditec AG, Jena (DE)

(72) Inventors: Stefan Saur, Aalen (DE); Gerald Panitz, Ellwangen (DE); Roland Guckler, Ulm (DE)

(21) Appl. No.: 14/723,162

(22) Filed: May 27, 2015

(30) Foreign Application Priority Data
May 27, 2014 (DE) 10 2014 107 443.2

(51) Int. Cl. G02B 21/00; G02B 21/36; G02B 21/06

(52) U.S. Cl. CPC G02B 21/0012; G02B 21/06; G02B 21/367; G02B 21/364

(57) ABSTRACT

A microscope system includes a microscope for generating a microscopic image of an observation region to be examined and a display unit for visualizing the microscopic image. The system further includes a registration unit and an evaluation unit. The registration unit is configured to register the three-dimensional structure of an observation object from available data to the position of the observation object in the observation region. The evaluation unit is configured to calculate a depth preview map of the three-dimensional structure of the observation object from available data and to transmit the depth preview map to the display unit for visualizing the three-dimensional structure in relation to the position of the observation object in the observation region.

### CROSS REFERENCE TO RELATED APPLICATION

This application claims priority of German patent application no. 10 2014 107 443.2, filed May 27, 2014, the entire content of which is incorporated herein by reference.

### FIELD OF THE INVENTION

The present invention relates to a microscope system, for example a surgical microscope system especially for neurosurgical applications. The invention furthermore relates to a microscopy method, for example for surgical microscopes especially for neurosurgical applications.

### BACKGROUND OF THE INVENTION

A tumor resection by means of a surgical microscope constitutes a general challenge in surgery. Particularly in the case of resection in functional regions, the exact three-dimensional morphology of the tumor has to be known to the surgeon in order to be able to choose the most exact possible cut boundary between functional tissue and malignant tissue during an intervention.

With currently available navigation solutions, the tumor margin calculated on the basis of pre-operative data, for example from MRI examinations, is displayed only for the current focal plane or focal slice or individual adjacent slices through the eyepiece in the surgical microscope.

For greater representation and identification of the three-dimensional tumor morphology, the surgeon must either call up a corresponding morphology from memory or, during the intervention, abandon the surgeon's customary view through the eyepiece of the surgical microscope in order to view an external visualization unit. Both the morphology learned beforehand and the momentary view of an external visualization unit pose risks for the patient since the operation flow is interrupted.

### SUMMARY OF THE INVENTION

Therefore, it is an object of the present invention to provide an advantageous microscope system and an advantageous microscopy method.

The microscope system according to the invention includes a microscope, for example a surgical microscope, for generating a microscopic image of an observation region to be examined. It furthermore includes a display unit, for example a visualization unit or a display, for visualizing the microscopic image. The microscope system additionally includes a registration unit and an evaluation unit. The microscope, the display unit, the registration unit and the evaluation unit are connected to one another, especially for data transfer.

The microscope system according to the invention is distinguished by the fact that the registration unit is configured to transfer the three-dimensional structure of an observation object from available data, for example data obtained at an earlier point in time, to the position of the observation object in the observation region. The observation object can be tissue, for example, especially tissue of a tumor. The registration unit can therefore be configured to register the morphology of the tissue, for example the tumor morphology, from pre-operative data to the current observation region or the current operation scene.

The microscope system according to the invention is furthermore distinguished by the fact that the evaluation unit is configured to calculate a depth preview map of the three-dimensional structure of the observation object from available data, for example data obtained at an earlier point in time, and to transmit the depth preview map to the display unit for visualizing the three-dimensional structure in relation to the position of the observation object in the observation region. By way of example, the evaluation unit can be configured to calculate the morphology of tissue, especially of a tumor, from available data and to transmit it to the display unit for visualizing the three-dimensional structure in relation to the position of the observation object in the observation region. The evaluation unit can be a PC, for example.

The problem—described above in connection with tumor resection—of the inadequate possibility of visualizing a tumor during an operative intervention can be solved with the aid of the microscope system according to the invention by means of a tumor depth preview map which visualizes the entire morphology of the tumor for example as iso-depth lines (aka isobaths) which are inserted directly into the eyepiece of the surgical microscope. For better differentiation, individual characteristic depth regions can optionally also be provided with color coding. The surgeon thus need not abandon the surgeon's customary view through the eyepiece of the surgical microscope. The surgeon need not rely on a morphology learned beforehand either. This improves the operation flow and reduces the abovementioned risks for the patient.

In principle, in the context of the microscope system according to the invention, techniques, such as the fusion of image data, for example, from the field of augmented reality can be used in order to enable a seamless and realistic insertion into the operation scene.

The microscope system advantageously comprises a measuring system configured for detecting the topography of the observation region, in particular of the current operation scene. The measuring system can comprise a stereoscopic sensor and/or a laser scanner and/or a sensor for time-of-flight measurement, for example a time-of-flight camera (TOF-camera), and/or an apparatus for structured illumination. The stereoscopic sensor can comprise for example two cameras integrated in the surgical microscope.

Optionally, the microscope system comprises a visualization system, for example in the form of a video camera, configured to detect images, for example current images, of the observation region, in particular of the operation scene, in order to combine them with the depth preview map. In principle, the visualization of the depth preview map or depth map can be effected as an opaque superimposition.

An alternative form of visualization is linear display of the iso-depth lines, wherein the lines can be shown as solid, dashed, dotted or in an arbitrary combination thereof. Any form of superimposition of iso-depth lines or opaque representation with the current operation scene or the observation region is also conceivable in order to enable realistic “look-and-feel”. Different visualization parameters can advantageously be chosen for visible and for non-visible regions of the malignant tissue.

In a further embodiment, the depth information can also be displayed in a locally delimited fashion, in order not to restrict the field of view of the examining person, for example the operating surgeon.

Preferably, the visualization is primarily effected in the eyepiece of the surgical microscope. Alternatively or additionally, the visualization can also be effected on an external display unit, for example a monitor, data spectacles or the like.

The registration unit can comprise a navigation device. It can be configured, in principle, for rigid or for non-rigid transfer or registration. The registration unit can be embodied for example in the form of a navigation device.

As already mentioned, the display unit can comprise an eyepiece display or external display. Furthermore, the display unit can be configured for visualizing the depth preview map or depth map as an opaque superimposition and/or for visualizing the depth preview map or depth map in the form of iso-depth lines. The externally embodied display unit can be a monitor or data spectacles, for example.

Overall, the microscope system according to the invention has the advantage that it enables an improved representation of the overall morphology of an observation object with an observation region, for example an improved representation of the overall morphology of malignant tissue within an operation scene.

In the context of the microscopy method according to the invention, a microscopic image of an observation region to be examined is generated by means of a microscope and visualized by means of a display unit. The three-dimensional structure of an observation object, for example of a tissue region, is transferred or registered from available data, in particular pre-operative data obtained at an earlier point in time, to the position of the observation object in the observation region, in particular to the current observation region or the current operation scene. Furthermore, a depth preview map of a three-dimensional structure of the observation object, for example of the tissue region, is calculated from available data, for example pre-operative data obtained at an earlier point in time. The calculated three-dimensional structure is visualized in relation to the position of the observation object in the observation region with the aid of the display unit.

The method according to the invention can be carried out for example with the aid of the above-described microscope system according to the invention. In principle, it has the advantages like the above-described microscope system according to the invention.

A registration unit described in the context of the microscope system according to the invention and/or an evaluation unit described in that context can advantageously be used. The observation region is preferably a surgical, for example neurosurgical, operation scene.

The topography of the observation region, for example the current operation scene, can advantageously be detected. A corresponding measuring system configured for detecting the topography of the observation region can be used for this purpose. The detection can be effected, in principle, stereoscopically, for example with the aid of a stereoscopic sensor, in particular with the aid of two video cameras integrated in the surgical microscope, and/or with the aid of a laser scanner and/or with the aid of a method for time-of-flight measurement, for example with the aid of a sensor for time-of-flight measurement such as preferably a TOF camera. Alternatively or additionally, the topography detection can be effected by means of structured illumination, for example with the aid of an apparatus for structured illumination.

As a result of the inclusion of current topography information, the depth information and the visualization thereof can be adapted to the current conditions. In a different extension, the intraoperative image data are used to compensate for a possible geographical deviation from pre- and intraoperative data for the visualization of the depth information. Various image processing algorithms and/or various illumination modes and/or markers, for example, contrast agents, can be used for this purpose.

In principle, the depth information can be detected with the aid of external navigation solutions. Specifically, the depth information can be detected by means of MRI (magnetic resonance imaging), CT (computed tomography) or the like. The navigation system can segment the data, that is, assign them to bone or tumor tissue, for example, and can supply them either as raw data or in a manner already corrected computationally to the optical axis of the surgical microscope.

In one embodiment thereof, the navigation system provides the entire depth information via an interface. In another embodiment, the surgical microscope, on the basis of the current focal plane, transmits “virtual depths” (distance of the adjustable image focus relative to the surgical microscope) in a defined range of values to an external navigation solution in order to obtain the respective contour of the malignant tissue in the pre-operative state for the transmitted depth. These contours are then combined to form the depth map in the surgical microscope.

Optionally, the microscopically generated images of the observation region to be examined, for example of the operation scene, are detected. They are subsequently combined with the depth preview map. In particular, a correspondingly configured visualization system, for example a video camera, can be used for this purpose.

In the context of the microscopy method, the depth preview map or depth map can be visualized as an opaque superimposition and/or in the form of iso-depth lines, for example with the aid of a display unit. The display unit used can comprise an eyepiece display or external display. It can be configured in particular for visualizing the depth map as an opaque superimposition and/or for visualization in the form of iso-depth lines. In particular, a monitor or data spectacles can be used as external display unit.

The transfer or registration of the three-dimensional structure of the observation object on the basis of available data to the position of the observation object in the observation region can be effected rigidly or non-rigidly, in principle. A registration unit configured for rigid or for non-rigid transfer or registration can be used for this purpose.

### BRIEF DESCRIPTION OF THE DRAWINGS

The invention will now be described with reference to the drawings wherein:

FIG. 1 is a schematic showing the construction of a surgical microscope;

FIG. 2 schematically shows, by way of example, a varifocal objective;

FIG. 3 schematically shows a surgical operation scene with depth preview map; and,

FIG. 4 is a schematic showing a microscope system according to the invention.

### DESCRIPTION OF THE PREFERRED EMBODIMENTS OF THE INVENTION

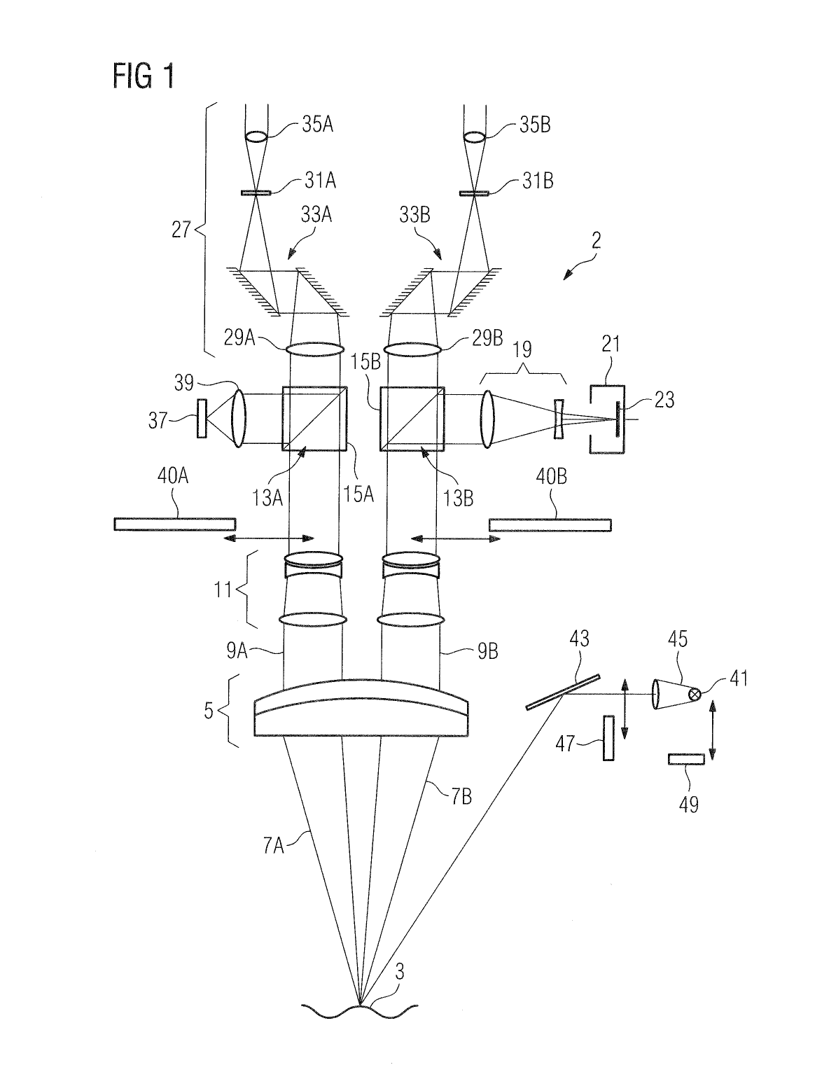

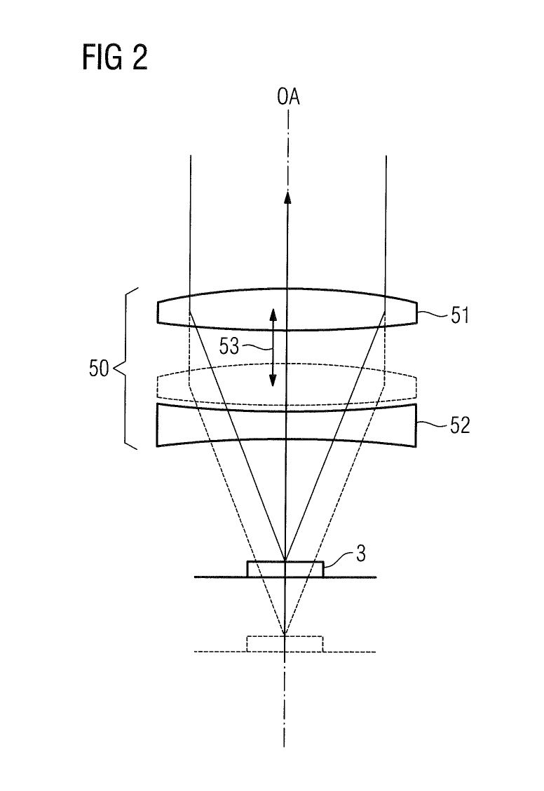

The fundamental construction of the surgical microscope 2 is explained below with reference to FIGS. 1 and 2.

The surgical microscope 2 shown in FIG. 1 includes, as essential component parts, an objective 5 disposed facing an object field 3. The objective can be embodied especially as an achromatic or apochromatic objective. In the present embodiment, the objective 5 consists of two sub-lenses cemented to one another and forming an achromatic objective. The object field 3 is arranged in the focal plane of the objective 5, such that it is imaged toward infinity by the objective 5. Stated otherwise, a divergent beam (7A, 7B) proceeding from the object field 3 is converted into a parallel beam 9 upon passing through the objective 5.

A magnification changer 11 is arranged at the observer side of the objective 5. The magnification changer can be embodied either, as in the embodiment shown, as a zoom system for changing the magnification factor in a continuously variable fashion or as a so-called Galilean changer for changing the magnification factor step by step. In a zoom system constructed, for example, from a lens combination including three lenses, the two object-side lenses can be displaced in order to vary the magnification factor. In actual fact, however, the zoom system can also comprise more than three lenses, for example, four or more lenses, wherein the outer lenses can then also be arranged in a fixed fashion.

In a Galilean changer, by contrast, there are a plurality of fixed lens combinations which represent different magnification factors and can be introduced into the beam path alternately. Both a zoom system and a Galilean changer convert an object-side parallel beam into an observer-side parallel beam having a different beam diameter. In the embodiment, the magnification changer 11 is already part of the binocular beam path of the surgical microscope 1, that is, it has a dedicated lens combination for each stereoscopic partial beam path (9A, 9B) of the surgical microscope 1. In the present embodiment, the setting of a magnification factor by the magnification changer 11 is effected by a motor-driven actuator which, together with the magnification changer 11, is part of a magnification changing unit for setting the magnification factor.

An interface arrangement (13A, 13B) is adjacent to the magnification changer 11 on the observer side. Via the interface arrangement, external devices can be connected to the surgical microscope 1 and which interface arrangement comprises beam splitter prisms (15A, 15B) in the present embodiment. In principle, however, other types of beam splitters can also be used, for example, partly transmissive mirrors. In the present embodiment, the interfaces (13A, 13B) serve for coupling out a beam from the beam path of the surgical microscope 2 (beam splitter prism 15B) and for coupling a beam into the beam path of the surgical microscope 2 (beam splitter prism 15A).

In the present embodiment, the beam splitter prism 15A in the component beam path 9A serves, with the aid of a display 37, (for example, a digital mirror device (DMD) or an LCD display), and an associated optical unit 39, via the beam splitter prism 15A, to reflect information or data for an observer into the component beam path 9A of the surgical microscope 1. In the other component beam path 9B, a camera adapter 19 with a camera 21 fixed thereto is arranged at the interface 13B. The camera is equipped with an electronic image sensor 23, for example, with a CCD sensor or a CMOS sensor. An electronic and especially a digital image of the tissue region 3 can be recorded by the camera 21. In particular, a hyperspectral sensor containing not just three spectral channels (for example, red, green and blue) but rather a multiplicity of spectral channels can also be used as the image sensor.

A binocular tube 27 is adjacent to the interface (13A, 13B) on the observer side. The binocular tube includes two tube objectives (29A, 29B) which focus the respective parallel component beams (9A, 9B) onto intermediate image planes (31A, 31B), that is, image the observation object 3 onto the respective intermediate image planes (31A, 31B). The intermediate images situated in the intermediate image planes (31A, 31B) are finally, in turn, imaged toward infinity by eyepiece lenses (35A, 35B) such that an observer can observe the intermediate image with a relaxed eye. Moreover, in the binocular tube, the distance between the two component beams (9A, 9B) is magnified by a mirror system or by prisms (33A, 33B) in order to adapt the distance to the intraocular distance of the observer. Image erection is additionally carried out by the mirror system or the prisms (33A, 33B).

The surgical microscope 2 is additionally equipped with an illumination apparatus that can be used to illuminate the object field 3 with broadband illumination light. For this purpose, in the present embodiment, the illumination apparatus includes a white light source 41, for instance a halogen incandescent lamp or a gas discharge lamp. The light emerging from the white light source 41 is directed via a deflection mirror 43 or a deflection prism in the direction of the object field 3 in order to illuminate the latter. Furthermore, an illumination optical unit 45 is present in the illumination apparatus and provides for uniform illumination of the entire observed object field 3.

It is noted that the illumination beam path shown in FIG. 1 is highly schematic and does not necessarily represent the actual course of the illumination beam path. In principle, the illumination beam path can be embodied as so-called oblique illumination that comes closest to the schematic shown in FIG. 1. In such oblique illumination, the beam path runs at a relatively large angle (6° or more) with respect to the optical axis of the objective 5 and, as shown in FIG. 1, can run completely outside the objective. Alternatively, however, there is also the possibility of allowing the illumination beam path of the oblique illumination to run through a marginal region of the objective 5. A further possibility for the arrangement of the illumination beam path is so called 0° illumination, in which the illumination beam path runs through the objective 5 and is coupled into the objective between the two component beam paths (9A, 9B) along the optical axis of the objective 5 in the direction of the object field 3. Finally, there is also the possibility of embodying the illumination beam path as so-called coaxial illumination, which contains a first and a second component illumination beam path. The component beam paths are coupled into the surgical microscope via one or a plurality of beam splitters parallel to the optical axes of the component observation beam paths (9A, 9B) such that the illumination runs coaxially with respect to the two component observation beam paths.

The illumination can be influenced in the surgical microscope shown in FIG. 1. By way of example, a filter 47 can be introduced into the illumination beam path which allows only a narrow spectral range from the wide spectrum of the white light source 41 to pass, for example, a spectral range that can be used to excite fluorescence of a fluorescent dye situated in the object field 3. For observing the fluorescence, filters (40A, 40B) can be introduced into the component observation beam paths (37A, 37B). These filters filter out the spectral range used for excitation of fluorescence in order to be able to observe the fluorescence.

The illumination apparatus can additionally be equipped with a unit for changing the illumination light source. The latter is indicated in FIG. 1 by a system for replacing the white light source 41 by a laser 49. By way of example, laser Doppler imaging or laser speckle imaging is made possible with a laser as light source, especially with an infrared laser, in conjunction with a suitable image sensor 23. In the present embodiment, the unit for changing the illumination light source is motor-driven and can be controlled from a pathology unit by suitable control data.

In the embodiment variant of the surgical microscope 2 shown in FIG. 1, the objective 5 consists only of one achromatic lens. However, an objective lens system composed of a plurality of lenses can also be used, especially a so-called varifocal objective, which makes it possible to vary the working distance of the surgical microscope 2, that is, the distance between the object-side focal plane and the vertex of the first object-side lens surface of the objective 5, also called front focal length. The object field 3 arranged in the focal plane is also imaged toward infinity by the varifocal objective 50, such that a parallel beam is present at the observer side.

One example of a varifocal objective is shown schematically in FIG. 2. The varifocal objective 50 comprises a positive element 51, that is, an optical element having positive refractive power shown schematically as a convex lens in FIG. 2. Furthermore, the varifocal objective 50 comprises a negative element 52, that is, an optical element having negative refractive power shown schematically as a concave lens in FIG. 2. The negative element 52 is situated between the positive element 51 and the object field 3. In the varifocal objective 50 shown, the negative element 52 is arranged in a fixed fashion, whereas the positive element 51 is arranged displaceably along the optical axis OA as indicated by the double-headed arrow 53. If the positive element 51 is displaced into the position shown by dashed lines in FIG. 2, the front focal length is lengthened, such that the working distance of the surgical microscope 2 from the object field 3 changes.

Although the positive element 51 is embodied in displaceable fashion in FIG. 2, in principle there is also the possibility of arranging the negative element 52, instead of the positive element 51, moveably along the optical axis OA. However, the negative element 52 often forms the terminating lens of the varifocal objective 50. A stationary negative lens 52 therefore affords the advantage that the interior of the surgical microscope 2 can be sealed more easily against external influences. Furthermore, it should be noted that, although the positive element 51 and the negative element 52 are shown only as individual lenses in FIG. 2, each of these elements can also be realized in the form of a lens group or a cement element instead of in the form of an individual lens, for example in order that the varifocal objective is embodied in an achromatic or aprochromatic fashion.

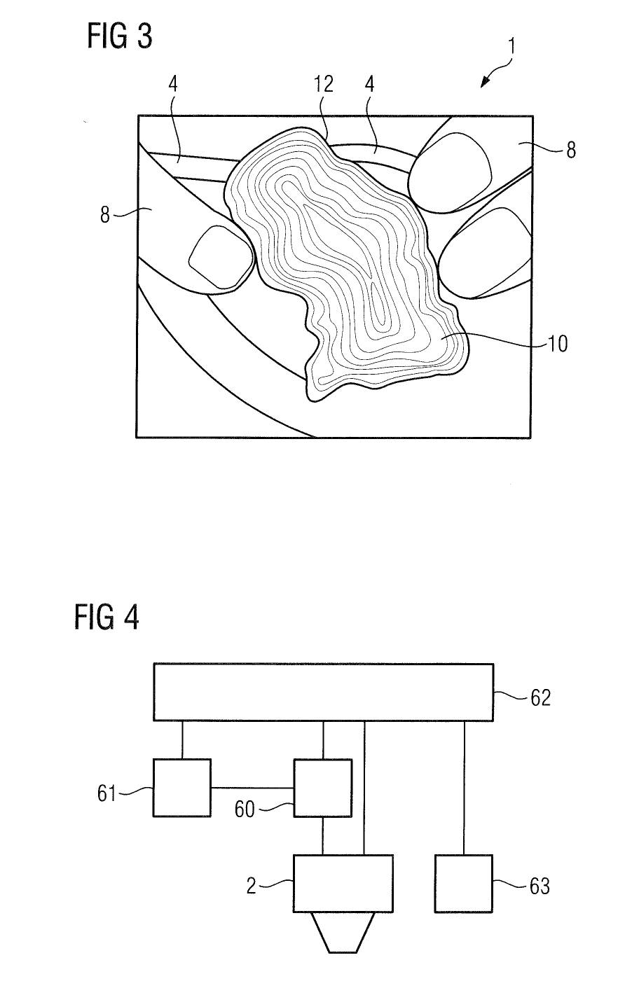

FIG. 3 schematically shows a surgical, for example neurosurgical, operation scene 1. The observation region presented microscopically by the surgical microscope, or the operation scene, comprises tissue 12 to be removed, for example tumor tissue to be removed in the context of a tumor resection. The surgeon's fingers are identified by the reference numeral 8, and the surgical instruments used are identified by the reference numeral 4. During the operation, in accordance with the method according to the invention, a tumor depth preview map 10 is inserted into the operation scene. This is carried out in the present case with the aid of iso-depth lines and by color coding.

In principle, it is possible here to use techniques from the field of augmented reality for the fusion of image data. This enables seamless and realistic insertion into the operation scene.

With the aid of the tumor depth preview map 10, the entire morphology of the tumor 12 is visualized as iso-depth lines, as shown in FIG. 3, and is inserted directly into the eyepiece of the surgical microscope. For better differentiation, individual characteristic depth regions can optionally also be provided with color coding. As an alternative to direct insertion into the eyepiece of the surgical microscope or in addition thereto, a visualization with the aid of an external display unit, for example a monitor, data spectacles or the like, is possible.

The depth information is detected for example with the aid of external navigation solutions. In this case, the navigation system can provide the entire depth information via an interface. In another embodiment, in addition or as an alternative thereto, on the basis of the current focal plane, the surgical microscope 2 can transmit “virtual depths” in a defined range of values to an external navigation solution in order to obtain each contour of the malignant tissue 12 in the pre-operative state for the corresponding transmitted depth.

In an extended variant of the topography information of the operation scene is detected by a suitable sensor, for example a stereoscopic sensor, a laser scanner, a time-of-flight sensor or with the aid of structured illumination. The stereoscopic sensor can comprise for example two video cameras integrated in the surgical microscope. As a result of the inclusion of current topography information, the depth information and the visualization thereof can be adapted to the current circumstances. In particular, deformations that occur can be taken into account.

As a further variant, the intra-operative image data are used to compensate for a possible geographical deviation from pre- and intra-operative data for the visualization of the depth information. Various image processing algorithms, illumination modes and markers, for example contrast agents, can be used for this purpose.

In principle, the visualization of the depth preview map or depth map can be effected as an opaque superimposition, as shown for example in FIG. 3. An alternative form of visualization is linear display of the iso-depth lines, wherein the lines are displayed as solid, dashed, dotted or in any desired combination thereof. Any form of superimposition of iso-depth lines or opaque representation with the current observation scene or operation scene is also possible in order to enable realistic “look-and-feel”. Different visualization parameters can be chosen for visible and non-visible regions of the malignant tissue. In a further embodiment the depth information can also be displayed in a locally delimited fashion in order not to restrict the field of view of the operating surgeon 8.

Preferably, the visualization is primarily effected in the eyepiece of the surgical microscope, for example as perspectively correct superimposition or as picture-in-picture (PiP) at the edge of the field of view in order to minimize the concealment of relevant image information. However, the visualization can optionally also be effected on an external display unit.

FIG. 4 schematically shows a microscope system according to the invention. The microscope system includes a surgical microscope 2, a display unit 60, a registration unit 61 and an evaluation unit 62, which are connected to one another for data transfer. The display unit 60 can be embodied as an eyepiece display or external display. The registration unit 61 can be embodied for example in the form of a navigation device. It can be configured especially for registering the tumor morphology from pre-operative data to the current operation scene. This can be carried out in rigid or non-rigid form. The evaluation unit 62 is configured to combine different sources of depth information and to calculate a depth preview map 10 therefrom. For this purpose, the evaluation unit 62 can comprise algorithms which combine data from different sources in relation to the depth information and calculate a depth preview map 10 therefrom. The evaluation unit 62 is furthermore configured to transmit the calculated depth preview map 10 to the display unit 60.

The surgical system can optionally include a measuring system 63 configured to detect the topography of the current operation scene. The microscope system can likewise optionally comprise a system, for example in the form of a video camera, configured to detect current images of the operation scene and to combine them with the depth preview map.

It is understood that the foregoing description is that of the preferred embodiments of the invention and that various changes and modifications may be made thereto without departing from the spirit and scope of the invention as defined in the appended claims.

### LIST OF REFERENCE SIGNS

1 Operation scene
2 Surgical microscope
3 Operation field
4 Surgical instruments
5 Objective
7 Divergent beam
8 Surgeon's fingers
9A, 9B Stereoscopic partial beam path
10 Tumor depth preview map
12 Tissue
11 Magnification changer
13A, 13B Interface arrangement
15A, 15B Beam splitter prism
19 Camera adapter
21 Camera
23 Image sensor
27 Binocular tube
29A, 29B Tube objective
31A, 31B Intermediate image plane
33A, 33B Prism
35A, 35B Eyepiece lens
37 Display
39 Optical unit
40A, 40B Spectral filter
41 White light source
43 Deflection mirror
45 Illumination optical unit
47 Spectral filter
49 Laser
50 Varifocal objective
51 Positive element
52 Negative element
53 Displacement path
60 Display unit
61 Registration unit
62 Evaluation unit
63 Measuring system

What is claimed is:

1. A microscope system comprising:
a microscope for generating a microscopic image of an observation region to be examined;
a display unit for visualizing said microscopic image;
a registration unit configured to register the three-dimensional structure of an observation object from available data to the position of said observation object in said observation region;
an evaluation unit configured to calculate a depth preview map of said three-dimensional structure of said observation object from available data and to transmit said depth preview map to said display unit for visualizing said three-dimensional structure in relationship to said position of said observation object; and,
said microscope, said display unit, said registration unit and said evaluation unit being connected with each other.

2. The microscope system of claim 1, further comprising a measuring system configured for detecting the topography of the observation region.

3. The microscope system of claim 2, wherein said measuring system includes at least one of a stereoscopic sensor, a laser scanner, a sensor for time-of-flight measurement and an apparatus for structured illumination.

4. The microscope system of claim 1, further comprising a visualization system configured to detect images of said observation region for combining with said depth preview map.

5. The microscope system of claim 1, wherein said registration unit includes a navigation device and/or is configured for rigid or non-rigid registration.

6. The microscope system of claim 1, wherein said display unit comprises an eyepiece display or an external display and/or is configured for visualizing said depth preview map as an opaque superimposition and/or for visualizing the depth preview map in the form of iso-depth lines.

7. A microscopy method in which a microscopic image of an observation region to be examined is generated by a microscope and is visualized by a display unit, the microscopy method comprising the steps of:
registering the three-dimensional structure of an observation object from available data to the position of the observation object in the observation region;
from available data, calculating a depth preview map of a three-dimensional structure of the observation object; and,
visualizing the calculated three-dimensional structure in relation to the position of the observation object in the observation region with the aid of the display unit.

8. The microscopy method of claim 7, wherein the topography of the observation region is detected.

9. The microscopy method of claim 7, wherein generated microscopic images of the observation region to be examined are detected and they are combined with the depth preview map.

10. The microscopy method of claim 7, wherein the depth preview map is visualized as an opaque superimposition and/or in the form of iso-depth lines.
